(19) United States
(12) Patent Application Publication
(10) Pub. No.: US 2006/0031508 A1
(43) Pub. Date: Feb. 9, 2006

(54) Method and system for providing recommended options for a host computer system attachment to data storage facility adapter ports

(75) Inventors: Andrew P. Gellai, Tucson, AZ (US); Jerry L. Coale, Prineville, OR (US)

Correspondence Address: SCULLY, SCOTT, MURPHY, & PRESSER, 400 GARDEN CITY PL, GARDEN CITY, NY, 11530, US

(73) Assignee: INTERNATIONAL BUSINESS MACHINES CORPORATION, ARMONK, NY (US)

(21) Appl. No.: 10/861,810

(22) Filed: Jun. 4, 2004

(51) Int. Cl. G06F 15/173

(52) U.S. Cl. 709/226

(57) ABSTRACT

Disclosed are a method and system for providing recommended options for a host computer system attachment to data storage facility adapter ports. The preferred embodiment of the invention utilizes an expert algorithm that provides these recommended setup options for host system fibre channel fabric attachment to storage facility host adapter ports. This algorithm, referred to as the FCFA algorithm, evaluates the data access performance requirements for a host system attachment and produces a recommendation to configure the attachment to a specific set of storage facility ports. A performance requirements evaluation is based on a cumulative rating of several performance related configuration factors that describe a storage facility and how a host system application is expected to access its allocated storage. Recommendation accuracy is gauged according to the availability of configuration factor information.

### REFERENCE TO RELATED APPLICATION

This application is related to the disclosure of copending application no. (Attorney Docket TUC920040011US1), for “A Method And System For Providing A Recommended Allocation Of Data Storage Space,” filed herewith, the disclosure of which is herein incorporated by reference in its entirety.

### BACKGROUND OF THE INVENTION

1. Field of the Invention

This invention generally relates to establishing connections between computer systems and data storage facilities. More specifically, the invention relates to the selection of the storage facility's I/O ports that are to be assigned for transmission of data between the host system and the facility's I/O ports.

2. Prior Art

As it is known in the art, computer systems generally include a central processing unit, a memory subsystem and a storage subsystem. According to a networked or enterprise model of a computer system, the storage subsystem associated with or in addition to a local computer system, may include a large number of independent storage devices or disks housed in a single enclosure. This array of storage devices is typically connected to several computers (or hosts) via dedicated cabling or via a network. Such a model allows for the centralization of data that is to be shared among many users and also allows a single point of maintenance for the storage functions associated with the many computer systems.

One type of storage system known in the art is one which includes a number of disk storage devices, configured as an array. Such a system may include several arrays of storage devices. In addition to the arrays of storage devices, typical storage systems include several types of controllers for controlling the various aspects of the data transfers associated with the storage system. One type of controller is a host controller and provides the interface between the host computers and the storage system. Another type of controller is a disk controller which is used to manage the transfer of data to and from an associated array of storage devices (e.g. disk drives). There may be one or more disk controllers for each array of storage devices in a storage system.

One difficult challenge that is faced when computer systems of the above general type are setup is to determine how best to connect the host computers to the storage facility. Current host system attachment to storage facility configuration planning processes are largely dependent on storage specialists, their learned expertise and on a configuration planner document that contains a large number of worksheets. A storage specialist will evaluate a customer's system attachment requirements and fill out a set of configuration planner worksheets that are used during storage facility installation at a customer's business site to guide a manual process for applying storage facility configuration settings.

A storage facility is not actually available for customer evaluation and production use until after the storage facility configuration processes are complete. Usually, a customer is satisfied with the final configuration results. However, there are occasions where customer expectations are not satisfied and steps must be taken to alter configuration settings, a process that may take many additional hours to complete.

### BRIEF SUMMARY OF THE INVENTION

An object of this invention is to provide a procedure for the selection of a data storage facility's I/O ports that are to be assigned to a host computer system for transmission of data between the host system and the data storage facility's I/O ports.

Another object of the invention is to help ensure sufficient bandwidth between a host computer system and a data storage facility, based on the data access performance requirements, at setup time.

A further object of the present invention is to provide a procedure for recommending, at installation time, to a user of a host computer system, the number and location of the physical I/O ports of a data storage facility that should be routed to the host system, based on the long-term performance requirements of the host system.

The present invention attains these and other objectives by the use of an expert algorithm that provides recommended setups options for host system attachment to storage facility host adapter ports. The preferred embodiment of the invention utilizes an expert algorithm that provides these recommended setup options for host system fibre channel fabric attachment to storage facility host adapter ports. This algorithm is thus referred to as the FCFA algorithm. The present invention can be implemented, for example, in the IBM TotalStorage ESS (Enterprise Storage System) Initial Setup Assistant (ISA) tool.

The FCFA algorithm evaluates the data access performance requirements for a host system attachment and produces a recommendation to configure the attachment to a specific set of storage facility ports. A performance requirements evaluation is based on a cumulative rating of several performance related configuration factors that describe a storage facility and how a host system application is expected to access its allocated storage. Recommendation accuracy is gauged according to the availability of configuration factor information. When information is unavailable or unknown, the FCFA algorithm defaults to a mid-scale evaluation that favors good, but not critical data access path performance.

Configuration factors used by the FCFA algorithm that concern host system attachment characteristics and storage requirements may be manually input via the ISA tool user interface (UI), or the ISA tool may inter operate with another software application to query a database containing host system profile information for an enterprise complex. Availability of an external database source is dependent on the ISA software application installation environment and application setup to enable inter operation with other compatible software applications.

Configuration factors used by the FCFA algorithm that concern a storage facility physical configuration features may be uploaded from an installed storage facility, imported from a storage facility purchase order program, or they may be manually input via the ISA tool UI.

An FCFA algorithm generated recommendation is presented to the ISA tool UI as part of the host system attachment configuration process. The purpose for providing a recommendation is to assist the user with making complex choices that would otherwise require expert knowledge about storage facility internal operations. However, as with all ISA tool recommendations, the user makes the final choice for host system attachment port quantity and port location.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 is a block diagram of a computer system including a mass storage system and with which the present invention may be used.

FIG. 2 is a flow chart showing a procedure for implementing this invention.

FIG. 3 is a more detailed flow chart illustrating a more specific example of the invention.

### DETAILED DESCRIPTION OF THE PREFERRED EMBODIMENTS

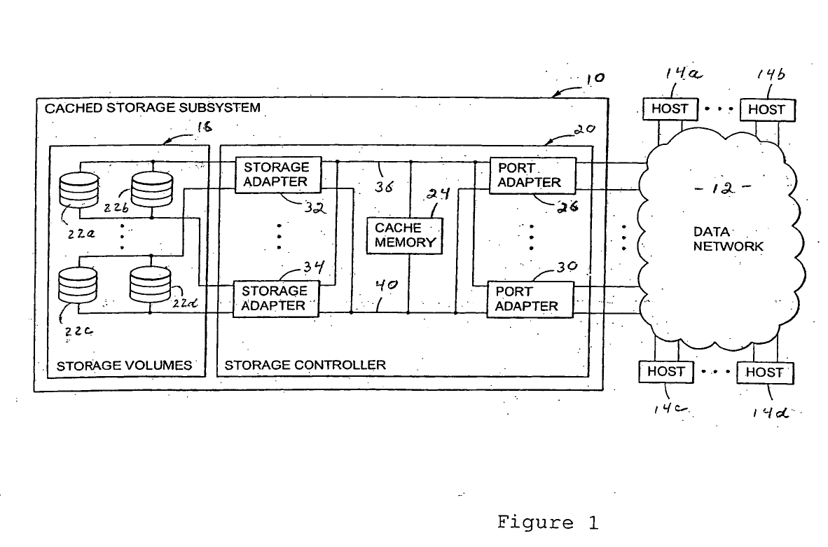

With reference to FIG. 1 of the drawings, there is shown a cached storage facility 10 connected via a data network 12 to a plurality of hosts 14a, 14b, 14c and 14d. The cached storage subsystem 10 includes storage volumes 16 and a storage controller 20 for controlling access of the hosts to the storage volumes. The storage volumes are logical units of storage distributed over one or more storage devices 22a, 22b, 22c and 22d. The storage devices may be magnetic disk drives, optical disk drives, tape drives, solid-state memory devices, or other storage devices capable of providing nonvolatile data storage. Presently, the preferred storage devices are magnetic disk drives.

The storage controller 20 includes a dual port cache memory 24, a plurality of port adapters 26 and 30, and a plurality of storage adapters 32 and 34. The cache memory 24 is accessed via any one of two back-plane busses 36 and 40. Each of the port adapters 32 and 34 links a respective set of the storage devices to each of the two back-plane busses. For example, the cached storage subsystem includes up to eight storage adapters and up to eight port adapters, and each port adapter provides two independent data ports to the data network.

The host computers may each be any of a well-known type of computer system. For example, host 14a may be a mainframe computer or may be an open system computer or alternatively may be a personal computer. Each of the computer systems just mentioned typically communicate using a special communications protocol

During operation, a host computer may desire to read data from or write data to one of the disk arrays contained within the storage facility 10. In order to do so, the host computer would send a request over its associated bus to the controller attached to that bus. The controller, once it receives the request from the host computer, begins performing those tasks necessary to satisfy the request.

The present invention provides a procedure for recommending a configuration for attaching the host computer systems to the storage facility. In its preferred implementation, the present invention addresses configuration setups for fibre channel fabric attachments (FCFA) to a storage facility.

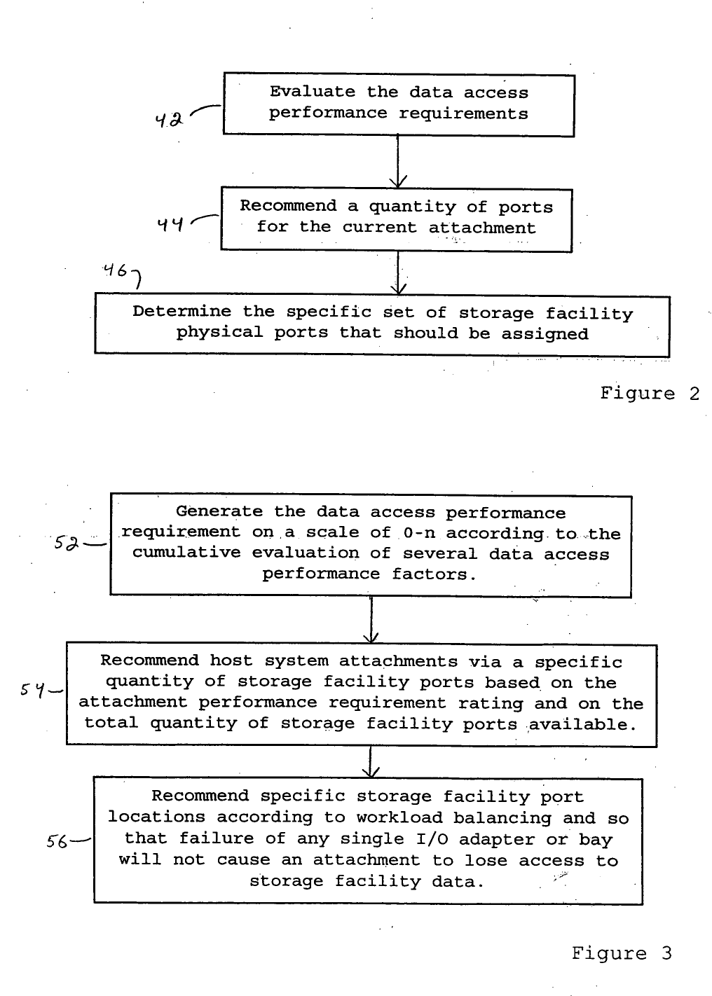

With reference to FIG. 2, the FCFA algorithm executes a three step process to arrive at a configuration setup recommendation. The first step 42 evaluates the data access performance requirement for a host system attachment and generates a rating value of 0-n. The second step 44 uses an attachment rating value along with storage facility host attachment port capability to determine a recommended quantity of ports for the current attachment. The third step 46 uses the accumulated attachment rating values of existing host system attachments to determine the specific set of storage facility physical ports that should be assigned to the current host system attachment for data access.

In preparation for the FCFA algorithm, the ISA tool allows the user to define individual ESS units and host systems and to specify attachments between the ESS units and the host systems. For each attachment being configured between and ESS unit and a host system, the ISA tool allows the user the option of providing performance information on the data that is to traverse on the attachment. The user-provided performance data is based on the user's own observations/experience with the host system's data access requirements based on applications running on the host system. If the user chooses not to provide the data, then the “normal” data access performance level will be assumed. Optionally, the performance information can be input to the ISA tool from other performance analysis/advisor tools (such as the ESS Expert tool).

The performance data, for example, may be comprised of twelve performance factors. Each performance factor yields a rating of 0-2. A rating of “0” indicates that data access performance for an attachment is “not critical.” A rating of “1” indicates that the performance requirement is “normal,” and a rating of “2” indicates that the performance requirement is “critical.” Greater rating scale granularity could be achieved with additional performance factors, or with additional rating points for any or all factors. The factors use by the ISA tool to rate the performance requirement for an attachment are listed below.

ReadTransactionType [Sequential=0][MixedUnknown=1][Random=2] WriteTransactionType [Sequential=0][MixedUnknown=1][Random=2] ReadTransactionFrequency [Seldom=0][MixedUnknown=1][Frequent=2] WriteTransactionFrequency[Seldom=0][MixedUnknown=1][Frequent=2] ReadXferSize [Small=0][ModerateUnknown=1][Large=2] WriteXferSize [Small=0][ModerateUnknown=1][Large=2] ReadCacheRatio [High=0][ModerateUnknown=1][Low=2] WriteCacheRatio [High=0][ModerateUnknown=1][Low=2] ResponseTime [NotCritical=0][ModerateUnkonwn=1][Critical=2] NumberUsers [Few=0][ModerateUnknown=1][Many=2] NumberInitiators [Few=0][ModerateUnknown=1][Many=2] NumberLuns [Few=0][ModerateUnknown=1][Many=2]

A middle scale value is chosen by default for any factor that can not be resolved from specific input information.

With reference to FIG. 3, in response to the user provided data, the FCFA algorithm process, at step 52, generates a data access performance requirement rating for the current attachment. The data access performance requirement for each host system attachment to a storage facility is rated on a scale of 0-n according to the cumulative evaluation of several data access performance factors. A rating of “0” indicates that data access performance for an attachment is not critical. A rating of “1-n” indicates a greater performance requirement, up to the point where fast data access is critical for each transaction from an attachment that has a very high and random transaction rate

The twelve performance factors listed previously allow for a cumulative performance rating scale of 0-24. This data access performance requirement rating is developed by the ISA tool for use by several configuration setup recommendation algorithms, including the FCFA algorithm. For example, as described in the above-identified application no. (Attorney Docket TUC920040011US1), this rating may also be used to provide recommended allocation of data storage space. The data access performance requirement rating for a host system attachment is most accurate when information about all factors is available.

The FCFA algorithm process, at step 54, recommends host system attachment via a specific quantity of storage facility fibre channel ports. The quantity of ports recommended is based on a host attachment performance requirement rating and on the total quantity of storage facility ports available. The minimum number of storage facility fibre channel ports recommended for any attachment is two ports. The maximum number recommended is eight ports, or the total number of installed ports, whichever is smaller. The quantity of ports recommended for a specific attachment is proportional to the attachment performance requirement rating and the maximum quantity of ports that would be recommended for a specific storage facility installation. For example, a performance rating at 50% of scale would cause the FCFA algorithm to recommend attachment to four ports, if eight or more ports are available. A performance rating of “0” causes the FCFA algorithm to recommend attachment to the minimum quantity of two ports.

The FCFA algorithm assumes that many host systems will be attached to a storage facility. If this is not the case, then the ISA tool user may choose to override an FCFA algorithm recommendation and assign more ports, or perhaps all storage facility ports, to a single host system attachment.

The FCFA algorithm process, at step 56, recommends specific storage facility port locations. The basic rule for any attachment is that the set of assigned ports should be spread across the storage facility I/O adapter bays and bay adapter slots so that failure of any single I/O adapter or bay will not cause an attachment to lose access to storage facility data. Additionally, the FCFA algorithm attempts to balance the workload allocations to all available storage facility ports. This is done by accumulating the performance requirement ratings for each host system assignment to individual ports, and then by making new assignments to those ports with the lowest accumulation of rating values.

For example, if an attachment performance rating is determined to be “24,” and that attachment is ultimately assigned to eight storage facility ports, then each of these eight ports will accumulate the rating value of “24.” The next host system attachment that an ISA tool user configures will result in the FCFA algorithm recommending attachment to a set of ports with accumulated rating values of less than “24,” if possible. This accumulation continues for each attachment and port assignment so that each FCFA algorithm recommendation is to attach via a set of ports that are expected to have the least amount of workload.

With the ISA tool recommendations, preferably, the user makes the final choice for host system attachment port quantity and port location. However, the ISA tool maintains and displays the performance requirement rating accumulation for each storage facility port so that each new assignment, whether resulting from an FCFA algorithm recommendation or from user selection, may be based on an effort to balance the workloads for all host system attachments. As each storage facility port may be associated with multiple hose attachments, the ISA tool can show a table of storage facility ports. For each storage facility port, the table shows their associated host attachments and the cumulative performance rating for the associated host attachments.

In addition, the ISA tool can show a graphic showing the storage facility ports and the storage facility arrays. Each port is highlighted by, for example, the color green, yellow or red, to indicate low, moderate or heavy loading on the port's path. When the user clicks on a port graphic, the arrays containing volumes assigned to host attachments through this port are also highlighted. With the table and the graphic, the user can review the host attachments, with the option of modifying the host attachments to redistribute the storage facility ports associated with the host attachments, in an effort to more evenly distribute the workload among all ports and to eliminate the “red spots.”

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of providing recommended options for a host computer system attachment to data storage facility adapter ports, the method comprising the steps of:
providing a performance requirements evaluation based on a cumulative rating of a given set of performance related configuration factors; and
determining a recommended number of adapter ports, using said evaluation, to be assigned to the host computer system attachment for data access.

2. A method according to claim 1, wherein:
the step of providing a performance requirements evaluation includes the step of generating a rating value of 0-n; and
the step of determining a recommended number of adapter ports includes the step of using said rating value, along with storage facility host attachment port capability, to determine a recommended quantity of ports for the attachment.

3. A method according to claim 2, wherein the step of determining a recommended number of adapter ports includes the further step of using accumulated attachment rating values of existing host system attachments to determine a specific set of storage facility physical ports that should be assigned to the current host system attachment for data access.

4. A method according to claim 2, wherein the step of using the rating value includes the step of recommending a specific quantity of ports based on said rating values and on the total quantity of storage facility ports available.

5. A method according to claim 1, wherein the performance related factors describe the storage facility and how the host system is expected to access its allocated storage in said facility.

6. A method according to claim 1, wherein the step of determining a recommended number of adapter ports includes the step of recommending a specific set of ports, said specific set of ports being spread across the storage facility I/O adapter bays and bay adapter slots so that failure of any single I/O adapter or bay will not cause an attachment to lose access to storage facility data.

7. A system for providing recommended options for a host computer system attachment to data storage facility adapter ports, the system comprising:
means for providing a performance requirements evaluation based on a cumulative rating of a given set of performance related configuration factors; and
means for determining a recommended number of adapter ports, using said evaluation, to be assigned to the host computer system attachment for data access.

8. A system according to claim 7, wherein:
the means for providing a performance requirements evaluation includes means for generating a rating value of 0-n; and
the means for determining a recommended number of adapter ports includes means for using said rating value, along with storage facility host attachment port capability, to determine a recommended quantity of ports for the attachment.

9. A system according to claim 8, wherein the means for determining a recommended number of adapter ports further includes means for using accumulated attachment rating values of existing host system attachments to determine a specific set of storage facility physical ports that should be assigned to the current host system attachment for data access.

10. A system according to claim 8, wherein the means for using the rating value includes means for recommending a specific quantity of ports based on said rating values and on the total quantity of storage facility ports available.

11. A system according to claim 7, wherein the performance related factors describe the storage facility and how the host system is expected to access its allocated storage in said facility.

12. A system according to claim 7, wherein the means for determining a recommended number of adapter ports includes means for recommending a specific set of ports, said specific set of ports being spread across the storage facility I/O adapter bays and bay adapter slots so that failure of any single I/O adapter or bay will not cause an attachment to lose access to storage facility data.

13. A program storage device readable by machine, tangibly embodying a program of instructions executable by the machine to perform method steps for providing recommended options for a host computer system attachment to data storage facility adapter ports, said method steps comprising:
providing a performance requirements evaluation based on a cumulative rating of a given set of performance related configuration factors; and
determining a recommended number of adapter ports, using said evaluation, to be assigned to the host computer system attachment for data access.

14. A program storage device according to claim 13, wherein:
the step of providing a performance requirements evaluation includes the step of generating a rating value of 0-n; and
the step of determining a recommended number of adapter ports includes the step of using said rating value, along with storage facility host attachment port capability, to determine a recommended quantity of ports for the attachment.

15. A program storage device according to claim 14, wherein the step of determining a recommended number of adapter ports includes the further step of using accumulated attachment rating values of existing host system attachments to determine a specific set of storage facility physical ports that should be assigned to the current host system attachment for data access.

16. A program storage device according to claim 14, wherein the step of using the rating value includes the step of recommending a specific quantity of ports based on said rating values and on the total quantity of storage facility ports available.

17. A program storage device according to claim 13, wherein the performance related factors describe the storage facility and how the host system is expected to access its allocated storage in said facility.

18. A program storage device according to claim 13, wherein the step of determining a recommended number of adapter ports includes the step of recommending a specific set of ports, said specific set of ports being spread across the storage facility I/O adapter bays and bay adapter slots so that failure of any single I/O adapter or bay will not cause an attachment to lose access to storage facility data.
